(19) United States
(12) Patent Application Publication
(10) Pub. No.: US 2020/0020111 A1
(43) Pub. Date: Jan. 16, 2020

(54) SINGLE FRAME OBJECT TRACKING USING THERMAL IMAGING

(71) Applicant: SIGNIFY HOLDING B.V., EINDHOVEN (NL)

(72) Inventors: HARRY BROERS, 'S-HERTOGENBOSCH (NL); RUBEN RAJAGOPALAN, NEUSS (DE)

(21) Appl. No.: 16/484,248

(22) PCT Filed: Feb. 5, 2018
(86) PCT No.: PCT/EP2018/052761

§ 371 Date: Aug. 7, 2019

(30) Foreign Application Priority Data
Feb. 16, 2017 (EP) 17156386.9

(51) Int. Cl. G06T 7/20; G01J 5/00

(52) U.S. Cl. CPC G06T 7/20; G06T 2207/30241; G01J 5/0022

(57) ABSTRACT

A method (400) for estimating a trajectory of an object (58) using thermal imaging, the method comprising the steps of: (i) obtaining (420), using a thermal imager (32), a thermal image (54) of one or more surfaces (50) within an environment (52); (ii) detecting (440), within a single obtained thermal image, a heat signature (56) from an object on the one or more surfaces; (iii) extracting (450), from the single obtained thermal image, a trajectory of the object along the one or more surfaces within the image; and (iv) estimating (460), from the extracted trajectory, a trajectory of the object within the environment.

### FIELD OF THE INVENTION

The present disclosure is directed generally to methods and systems for estimating a trajectory of an object within an environment using thermal imaging.

### BACKGROUND

There are many applications for systems capable of tracking the movement of objects within an environment. While some systems track the motion of objects in real-time, other systems track the movement of objects in recorded video or images. Methodologies utilized to track objects within recorded video or images typically rely on either the analysis of multiple frames or images, or the comparison of a frame to an aggregated background model or reference.

Accordingly, these systems will acquire or access a first frame or image, and then detect the object within that frame or image. The system will then acquire or access a second frame or image, detect the object within the second frame or image, and then compare the location of the object in the first frame to the location of the object in the second frame. Using the different in location of the object between the first frame and the second frame, the system can roughly estimate a trajectory for the object. However, these comparisons are computationally expensive, and require the existence of multiple frames or images for analysis.

Thermal imaging hardware has become increasingly more affordable, and thus thermal imaging applications are desirable. For example, thermal imaging can be used for presence sensing, in which thermal energy emitted by a human body is acquired by the thermal imager and with image analysis the presence and/or location of a person can be determined. Additionally, when a person makes physical contact with an object, body heat is transferred from the person to that object. This thermal imprint is visible with the thermal imager, but will fade away as the heat dissipates. Although some thermal imaging systems are configured to perform object tracking, these systems compare a thermal heat signature in a first frame or image to a thermal heat signature in a second frame or image, and thus require multiple frames or images for analysis.

Accordingly, there is a continued need in the art for methods and systems that track an object within an environment using thermal imaging, and more specifically that estimate the trajectory of an object using information extracted from a single thermal image.

### SUMMARY OF THE INVENTION

The present disclosure is directed to inventive methods and apparatus for estimating a trajectory of an object within an environment using thermal image information. Various embodiments and implementations herein are directed to a device comprising a thermal imager. The thermal images are analyzed to detect a heat signature from an object, and based on that heat signature a past trajectory of the object is extracted. A trajectory of the object beyond the detected heat signature is then estimated. The estimated trajectory of the object can be utilized to modify a lighting unit or any other environmental parameter or characteristic, and/or to characterize an object or an environment, among many other uses.

Generally, in one aspect, a method for estimating a trajectory of an object using thermal imaging is provided. The method includes the steps of: (i) obtaining, using a thermal imager, a thermal image of one or more surfaces within an environment; (ii) detecting, within a single obtained thermal image, a heat signature from an object on the one or more surfaces; (iii) extracting, from the single obtained thermal image, a trajectory of the object along the one or more surfaces within the image; and (iv) estimating, from the extracted trajectory, a trajectory of the object within the environment.

According to an embodiment, the estimated trajectory is outside the field of view of the thermal image.

According to an embodiment, the method further includes the step of responding to the estimated trajectory. According to an embodiment, the response comprises communicating information about the estimated trajectory. According to an embodiment, the response comprises communicating, based on the estimated trajectory, information about the one or more surfaces. According to an embodiment, the response comprises modifying, based on the estimated trajectory of the object within the environment, a characteristic of a lighting unit.

According to an embodiment, the method further includes the step of triggering, in response to a triggering event, the thermal imager to obtain or analyze a thermal image.

According to an embodiment, the method further includes the step of extracting additional information about the object using the detected heat signature.

According to an embodiment, the method further includes the step of communicating the thermal image to a processor of the thermal imager or to another thermal imaging device or system.

According to an aspect is a thermal imaging device configured to estimate a trajectory of an object using thermal imaging. The device includes: a thermal imager configured to obtain one or more thermal images of one or more surfaces; and a controller configured to: (i) detect, within a single obtained thermal image, a heat signature from an object on the one or more surfaces; (ii) extract, from the single obtained thermal image, a trajectory of the object along the one or more surfaces within the image; and (iii) estimate, from the extracted trajectory, a trajectory of the object within the environment.

According to an aspect is a thermal imaging system configured to estimate a trajectory of an object using thermal imaging. The system includes: a thermal imager component comprising a thermal imager and a communications module, wherein the thermal imager is configured to obtain one or more thermal images of one or more surfaces; and a controller configured to: (i) receive, from the communications module, one or more of the one or more thermal images; (ii) detect, within a single obtained thermal image, a heat signature from an object on the one or more surfaces; (iii) extract, from the single obtained thermal image, a trajectory of the object along the one or more surfaces within the image; and (iv) estimate, from the extracted trajectory, a trajectory of the object within the environment.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources.

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic representation of a thermal imaging device, in accordance with an embodiment.

FIG. 2 is a schematic representation of a thermal imaging system, in accordance with an embodiment.

FIG. 3 is a schematic representation of a thermal imaging system, in accordance with an embodiment.

FIG. 4 is a flow chart of a method for estimating a trajectory of an object using information extracted from a single thermal image, in accordance with an embodiment.

FIG. 5 is a schematic representation of a thermal image, in accordance with an embodiment.

FIG. 6 is a schematic representation of a thermal image, in accordance with an embodiment.

### DETAILED DESCRIPTION OF EMBODIMENTS

The present disclosure describes various embodiments of a thermal imaging system configured to characterize an object or environment. More generally, Applicant has recognized and appreciated that it would be beneficial to provide a system that obtains and analyzes thermal images of an environment through which one or more objects leaving a heat signature will move. A particular goal of utilization of certain embodiments of the present disclosure is to characterize an object or the environment using thermal imaging information.

In view of the foregoing, various embodiments and implementations are directed to a device or system with a thermal imager that obtains one or more thermal images of the environment. A processor of the device or system analyzes one of the thermal images to detect a heat signature from an object that has recently moved through the environment. The processor then extracts the past trajectory of the object based on the heat signature, and estimates a future or ongoing trajectory of the object using the extracted trajectory. The determined trajectory can then be utilized to characterize the object and/or the environment, and/or to modify a parameter or characteristic of the environment.

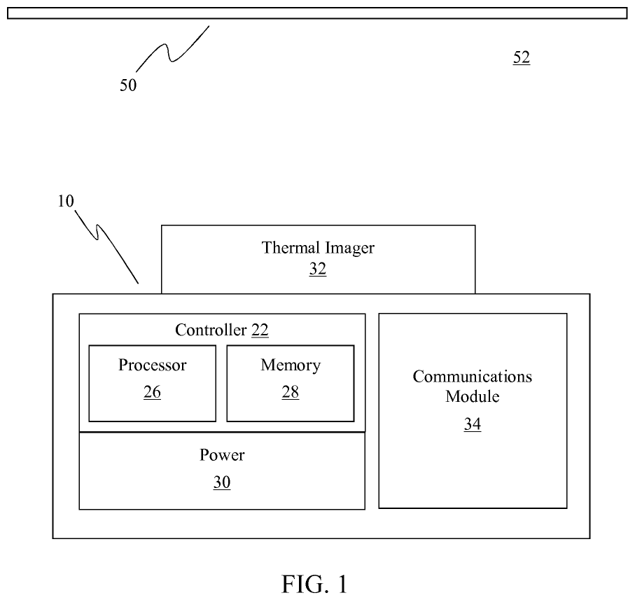

Referring to FIG. 1, in one embodiment, a thermal imaging device 10 is provided. Thermal imaging device 10 is configured to obtain an image of all or a portion of a target surface 50 within an environment 52. According to an embodiment, thermal imaging device 10 includes a controller 22 that is configured or programmed to direct a thermal imager 32 to obtain one or more images. Controller 22 can be or have, for example, a processor 26 programmed using software to perform various functions discussed herein, and can be utilized in combination with a memory 28. Memory 28 can store data, including one or more commands or software programs for execution by processor 26, as well as various types of data including but not limited to specific identifiers for that device. For example, the memory 28 may be a non-transitory computer readable storage medium that includes a set of instructions that are executable by processor 26, and which cause the system to execute one or more of the steps of the methods described herein.

Thermal imaging device 10 also includes a source of power 30, most typically AC power, although other power sources are possible including DC power sources, solar-based power sources, or mechanical-based power sources, among others. The power source may be in operable communication with a power source converter that converts power received from an external power source to a form that is usable by the device. In order to provide power to the various components of thermal imaging device 10, it can also include an AC/DC converter (e.g., rectifying circuit) that receives AC power from an external AC power source 30 and converts it into direct current for purposes of powering the device's components. Additionally, thermal imaging device 10 can include an energy storage device, such as a rechargeable battery or capacitor, that is recharged via a connection to the AC/DC converter and can provide power to the device when the circuit to AC power source 30 is opened.

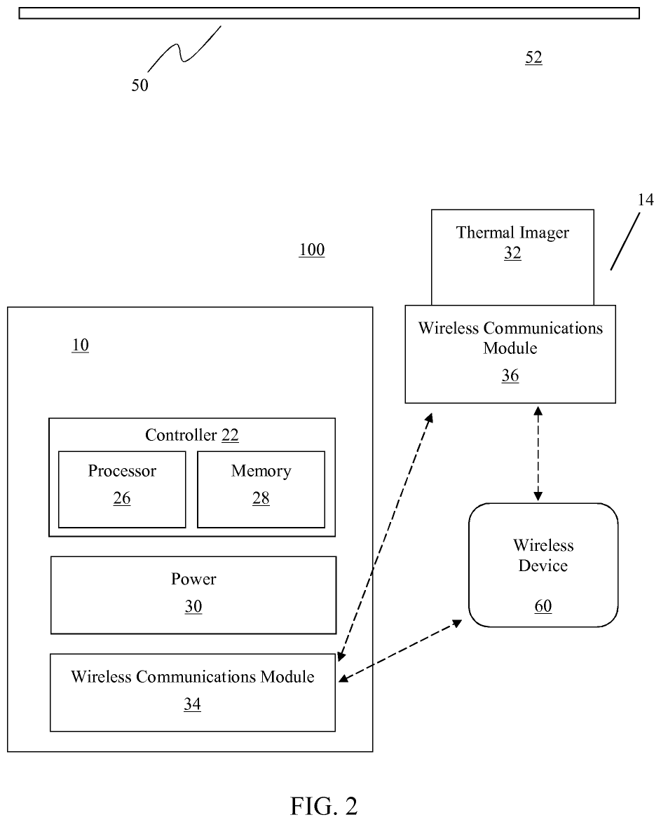

In addition, thermal imaging device 10 includes a thermal imager 32 which is connected to an input of controller 22 and collects thermal images in or from the vicinity of thermal imaging device 10 and can transmit data to controller 22, or externally via wireless communications module 34, that is representative of the thermal images it collects. In some embodiments such as system 100 depicted in FIG. 2, thermal imager 32 is remote from the thermal imaging device 10 and transmits obtained thermal imaging data to wireless communications module 34 of the device. The wireless communications module 34 can be, for example, Wi-Fi, Bluetooth, IR, radio, or near field communication that is positioned in communication with controller 22 or, alternatively, controller 22 can be integrated with the wireless communications module.

Referring to FIG. 2, in one embodiment, a thermal imaging system 100 is provided that includes a thermal imaging device 10. The thermal imaging device 10 in system 100 may only perform thermal imaging analysis. According to another embodiment, thermal imaging device 10 can be any of the embodiments described herein or otherwise envisioned, and can include any of the components of the devices described in conjunction with FIG. 1, such as a controller 22 and wireless communications module 34, among other elements. Thermal imaging system 100 also includes a thermal imager component 14 which includes a thermal imager 32 and a wireless communications module 36, among other elements. Wireless communications modules 34 and 36 can be, for example, Wi-Fi, Bluetooth, IR, or near field communication that is positioned in communication with each other and/or with a wireless device 60, which can be, for example, a network, a computer, a server, or a handheld computing device, among other wireless devices.

According to an embodiment, the thermal imager 32 of thermal imager component 14 is configured to obtain an image of all or a portion of a target surface 50 within the environment 52.

Thermal imaging system 100 can comprise multiple thermal imaging devices 10. For example, thermal imaging system 100 can be an entire office building, a floor of a building, a suite of rooms, a complex of buildings, or any other configuration comprise multiple thermal imaging devices. These multiple devices can be configured to communicate with each other and/or with a central computer, server, or other central hub. One or more aspects of the functionality of the methods and systems described or otherwise envisioned herein may occur within the central hub rather than within the individual thermal imaging devices. For example, the central hub may extract information from thermal images captured by one or more devices and transmitted or otherwise communicated to the central hub.

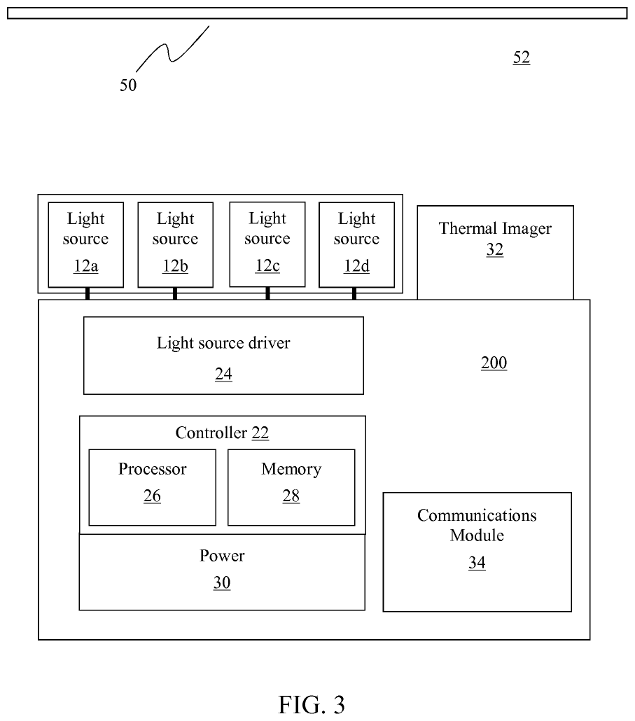

Referring to FIG. 3, in one embodiment, is a lighting unit 200 that includes one or more light sources 12, where one or more of the light sources may be an incandescent light source, a halogen light source, and/or a LED-based light source. The light source can be driven to emit light of predetermined character (i.e., color intensity, color temperature) by one or more light source drivers 24. Many different numbers and various types of light sources (all LED-based light sources, LED-based and non-LED-based light sources alone or in combination, etc.) adapted to generate radiation of a variety of different colors may be employed in the lighting unit 200. According to an embodiment, lighting unit 200 can be any type of lighting fixture, including but not limited to a night light, a street light, a table lamp, or any other interior or exterior lighting fixture. According to an embodiment, lighting unit 200 is configured to illuminate all or a portion of a target surface 50 and/or an object within a lighting environment 52.

According to an embodiment, lighting unit 200 includes a controller 22 that is configured or programmed to output one or more signals to drive the one or more light sources 12a-d and generate varying intensities, directions, and/or colors of light from the light sources. For example, controller 22 may be programmed or configured to generate a control signal for each light source to independently control the intensity and/or color of light generated by each light source, to control groups of light sources, or to control all light sources together. According to another aspect, the controller 22 may control other dedicated circuitry such as light source driver 24 which in turn controls the light sources so as to vary their intensities. Controller 22 can be or have, for example, a processor 26 programmed using software to perform various functions discussed herein, and can be utilized in combination with a memory 28. Memory 28 can store data, including one or more lighting commands or software programs for execution by processor 26, as well as various types of data including but not limited to specific identifiers for that lighting unit. For example, the memory 28 may be a non-transitory computer readable storage medium that includes a set of instructions that are executable by processor 26, and which cause the system to execute one or more of the steps of the methods described herein.

Controller 22 can be programmed, structured and/or configured to cause light source driver 24 to regulate the intensity and/or color temperature of light source 12 based on predetermined data, such as ambient light conditions, among others, as will be explained in greater detail hereinafter. According to one embodiment, controller 22 can also be programmed, structured and/or configured to cause light source driver 24 to regulate the intensity and/or color temperature of light source 12 based on communications received by a wireless communications module 34.

Lighting unit 200 also includes a source of power 30, most typically AC power, although other power sources are possible including DC power sources, solar-based power sources, or mechanical-based power sources, among others. The power source may be in operable communication with a power source converter that converts power received from an external power source to a form that is usable by the lighting unit. In order to provide power to the various components of lighting unit 200, it can also include an AC/DC converter (e.g., rectifying circuit) that receives AC power from an external AC power source 30 and converts it into direct current for purposes of powering the light unit's components. Additionally, lighting unit 200 can include an energy storage device, such as a rechargeable battery or capacitor, that is recharged via a connection to the AC/DC converter and can provide power to controller 22 and light source driver 24 when the circuit to AC power source 30 is opened.

In addition, lighting unit 200 includes a thermal imager 32 which is connected to an input of controller 22 and collects thermal images in or from the vicinity of lighting unit 200 and can transmit data to controller 22, or externally via wireless communications module 34, that is representative of the thermal images it collects. In some embodiments such as system 200 depicted in FIG. 2, thermal imager 32 is remote from the lighting unit 200 and transmits obtained thermal imaging data to wireless communications module 34 of the lighting unit. The wireless communications module 34 can be, for example, Wi-Fi, Bluetooth, IR, radio, or near field communication that is positioned in communication with controller 22 or, alternatively, controller 22 can be integrated with the wireless communications module.

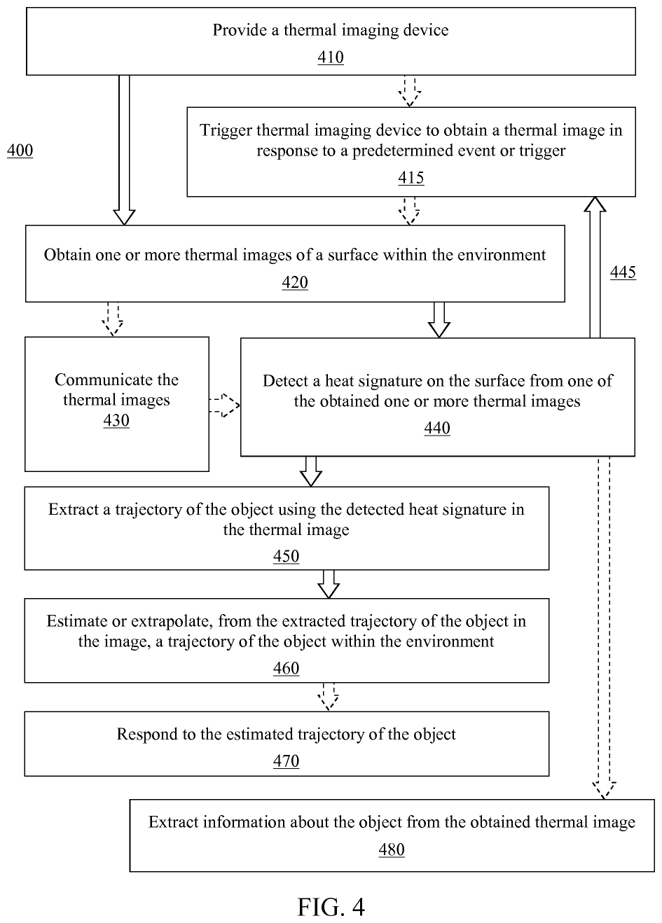

Referring to FIG. 4, in one embodiment, a flow chart illustrating a method 400 for estimating a trajectory of an object using information extracted from a single thermal image. At step 410 of the method, a thermal imaging device 10 and/or system 100 or 200 is provided. Thermal imaging device 10 and/or system 100 or 200 can be any of the embodiments described herein or otherwise envisioned, and can include any of the components of the devices or lighting units described in conjunction with FIGS. 1-3, including but not limited to controller 22, thermal imager 32, and wireless communications module 34, among other elements. According to an embodiment, thermal imaging device 10 is configured to obtain an image of all or a portion of a target surface 50 within an environment 52.

At step 420 of the method, the thermal imager 32 of the thermal imaging device 10 obtains one or more thermal images 54 of one or more surfaces 50 within an environment 52. The thermal imager can be, for example, any thermal imager capable of obtaining thermal images of the one or more surfaces within the environment. The thermal imager communicates the thermal images or thermal imaging information to the controller 22, where the information can be analyzed and/or can be stored within memory 28. According to one embodiment, the thermal imager obtains thermal imaging data continuously. According to another embodiment, the thermal imager obtains thermal imaging data periodically, such as once every minute or multiple times per minute, among many other periods of time. According to one embodiment, the thermal imager communicates or controller 22 communicates the thermal images to a central hub for analysis.

According to an embodiment, the thermal information is a thermal signature resulting from a heated object currently within and/or recently within the environment. It should be recognized that a “thermal signature” refers to either a thermal shadow or a signature resulting from heat generated by an object within the environment. For example, when a person makes physical contact with an object, body heat will be transferred to the object, and the thermal signature will be visible with the thermal imager but will fade away after a while as the heat dissipates and the surface returns to room temperature. In addition to body heat, thermal signatures can be left behind by vehicles that exchange temperature due to friction between the road surface and one or more wheels. Vehicle wheels often heat up considerably during certain maneuvers or long trips, for example.

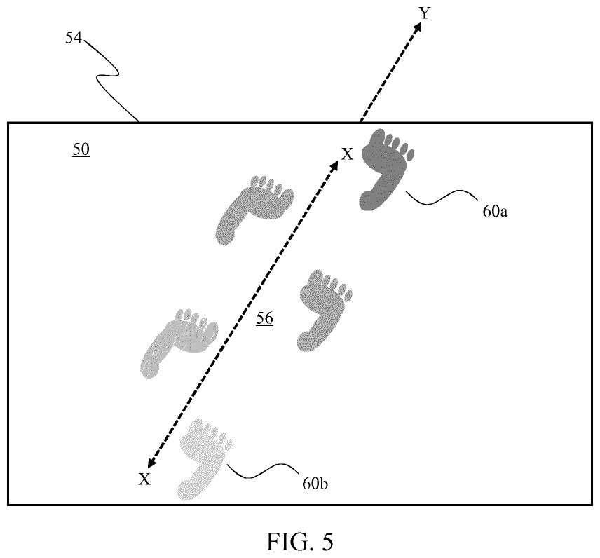

Referring to FIG. 5, as just one example, is a thermal image 54 of the one or more surfaces 50 in environment 52, obtained by the thermal imager 32 of thermal imaging device 10. An object 58 (not shown) has recently moved through the environment along the surface, leaving behind a thermal signature trail 56. Thermal signature trail 56 comprises footprints in this example, with varying intensity of the heat signature from a higher intensity 60a (indicating more recent footprints) to a lower intensity 60b (indicating older footprints). Although the intensity difference may be higher or lower than the difference shown in FIG. 5, the system may be able to utilize that information to determine or estimate vector directionality, as described herein. According to yet another embodiment, the heat signature may not vary intensity, instead being largely constant along the entire surface.

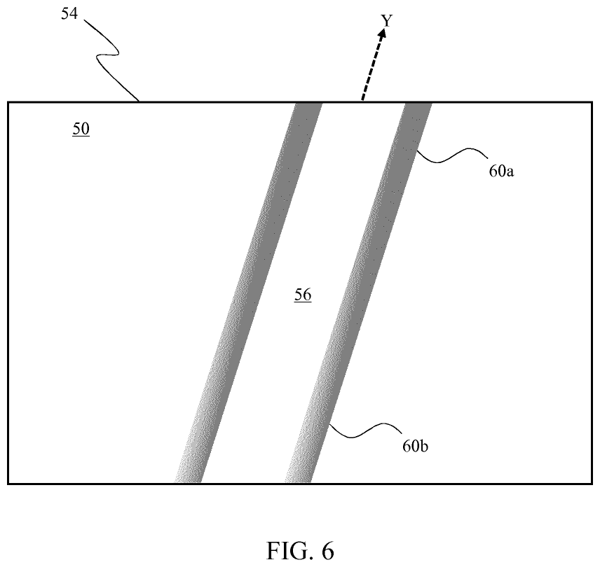

Referring to FIG. 6, in one embodiment, is a thermal image 54 of the one or more surfaces 50 in environment 52, obtained by the thermal imager 32 of thermal imaging device 10. An object 58 (not shown) has recently moved through the environment along the surface, leaving behind a thermal signature trail 56. Thermal signature trail 56 comprises tire tracks in this example, with varying intensity of the heat signature from a higher intensity 60a (indicating more recent travel) to a lower intensity 60b (indicating older travel). Although the intensity difference may be higher or lower than the difference shown in FIG. 6, the system may be able to utilize that information to determine or estimate vector directionality, as described herein. According to yet another embodiment, the heat signature may not vary intensity, instead being largely constant along the entire surface.

Optionally, another system or sensor may trigger the thermal imaging device or system to obtain a thermal image. Accordingly, at optional step 415 of the method, the system is trigger to obtain a thermal image based on a predetermined event or trigger. For example, a motion sensor or other presence sensor, a microphone, and/or other device integrated in and/or in wired or wireless communication with the thermal imaging device or system may detect the presence of an object within the field of view of the thermal imager, or otherwise within the vicinity of the thermal imager. The system may also comprise a timer actuated by the detection of a triggering event in order to track an amount of time prior to obtaining an optimized thermal image. For example, the system may be configured or designed to preferably obtain a thermal image after the object has left the thermal imager's field of view. In addition to the thermal imager itself, a motion sensor, another presence sensor, or a microphone, any other sensor, device, or trigger may actuate the thermal imager to obtain one or more thermal images.

At optional step 430 of the method, the thermal image or images are communicated to the processor, another thermal imaging device 10, to another component of system 100 or 200, and/or to a central hub, computer, server, or processor. The thermal imaging device 10 may be in direct and/or networked wired and/or wireless communication with the processor, other thermal imaging device 10, the other component of system 100 or 200, and/or the central hub, computer, server, or processor. Accordingly, the processor, other thermal imaging device 10, the component of system 100 or 200, and/or the central hub, computer, server, or processor may be located with, near, or remote from the thermal imaging device 10.

At step 440 of the method, the processor analyzes at least one of the obtained one or more thermal images to probe for the presence of a heat signature 56 from an object 58 left behind on the one or more surfaces 50. The thermal image may be a frame from a video or a single image. The processor may analyze the obtained thermal image using any of a variety of methods for identifying the presence of a heat signature 56. For example, the processor may look for pixels or regions of the thermal image that exceed a predetermined intensity threshold, thereby indicating the presence of a heat signature 56. As another example, the processor may compare pixels from a first region of the thermal image to pixels from a second region of the thermal image, and/or compare pixels from the obtained thermal image to a reference image or intensity, in order to identify the presence of a heat signature 56 from an object 58 left behind on the one or more surfaces 50. Although the processor may analyze every frame of a video or every image obtained, the system may also be configured or programmed to sample frames or images at a predetermined or random interval. The method may automatically proceed to a next step regardless of the outcome of the analysis, or the method may only proceed to a next step if a determined or suspected heat signature 56 is detected.

At optional step 445 of the method, the system performs a calibration of the thermal imaging device, and/or returns to step 415 or 420 of the method to obtain a new thermal image. For example, an additional calibration can be used to further optimize the system by extending the time between successive frame acquisitions. A larger observation period will result in more footsteps depending on the fading time of the thermal imprints. This can be used to minimize the frame rate resulting in a lower demand for computational resources and improved robustness. For example, the system may determine from a thermal image that an object traveled or is traveling along surface 50 at time 0, and the system is programmed or has learned that optimal thermal imaging is obtained at time 0+60 seconds. Accordingly, the system directs the thermal imager to obtain a new thermal image for processing and analysis at time 0+60 seconds. Many other time periods and options are possible.

According to an embodiment, since a thermal signature will fade over time, the system may utilize a recorded thermal image to extract the trajectory of the object. For example, the system may determine that a thermal image currently being analyzed comprises a dim heat signature, and will direct the processor to use a thermal image from X minutes ago when the heat signature has not dissipated, where X is a predetermined or learned amount of time.

At step 450 of the method, the processor extracts a trajectory of the object 58 along the one or more surfaces 50 within the single thermal image 54. The processor analyzes the identified heat signature 56 and determines in what direction object was traveling along the one or more surfaces 50. As an example, the processor may identify multiple heat signature tracks within the image, such as multiple footprints, or may identify an elongated heat signature track such as a tire track or other heat signature track. In each case, the heat signature 56 comprises a directionality that allows the processor to extract a trajectory that the object took along the one or more surfaces within the single thermal image 54. Without additional information, the extracted trajectory may comprise several possible directions. For example, referring to FIG. 5, without additional information the identified heat signature trail 56 may go in either direction along the X-X axis. However, information such as directionality of the footprints—such as recognizing the pattern of a heel end of the footprint and/or a toe end of the footprints—or the decaying intensity of the thermal signature may provide cues or clues for a more specific directionality of the trajectory. In FIG. 5, for example, both the direction of the footprints and the decaying intensity of the thermal signature may provide that information. In contrast, in FIG. 6 only the decaying intensity of the thermal signature may provide that information. In other embodiments, objects may only move in one direction along the one or more surfaces, or there may be other information to provide or suggest directionality of the trajectory.

Notably, because the analysis is performed using a single image, the approach is more robust and less computationally-expensive, and enables very low sample frequencies of the thermal imager, in accordance with an embodiment.

At step 460 of the method, the processor estimates or extrapolates, from the extracted trajectory of the object in the image, a trajectory of the object within or through the environment. This allows the processor to estimate, using the single thermal image, the trajectory that the object is taking or has taken through the environment, even outside the boundaries of the thermal image. The trajectory may be, for example, the intended route of the person or object within the environment. In FIG. 5, for example, the trajectory along axis X-X is extracted by the processor, and then that trajectory is utilized to estimate the trajectory Y in the environment. Although the trajectory Y is a straight line in FIG. 5, it could be a more complicated trajectory if the object takes a more complicated path within the thermal image, or is predicted to take a more complicated trajectory outside the boundary of the thermal image.

At step 470 of the method, the thermal imaging device or system, or any other system in wired and/or wireless communication with the thermal imaging device or system, can perform an action in response to the estimated trajectory of the object. For example, based on the estimated trajectory of the object within the environment, a characteristic of a lighting unit can be modified. For example, the thermal imaging device 10 can utilize the estimated trajectory to adjust or otherwise adapt the light profile emitted by the lighting unit or system. According to an embodiment, the controller can adjust the beam width, angle, and/or intensity of one or more light sources. Similarly, the information could be utilized to change a feature, parameter, or characteristic of the lighting environment over which the system has control. For example, certain rooms may be illuminated based on a prediction that the object is headed for that room, or certain streetlights may be activated based on a prediction that the object is headed in that direction. An outdoor lighting unit can provide way-finding guidance lighting along routes where most thermal imprints are visible within a single image.

The system may provide specific light signaling which visually indicates information related to the estimated trajectory. For example, an outdoor lighting unit can provide vehicle and road diagnostics information based on the heat imprint history of vehicles within the scene.

As another example, the system and method can be utilized to analyze and communicate one or more properties or characteristics of road conditions that can help to improve overall road safety. For instance, portions of roads that are highly prone to skidding can be analyzed using the thermal signature left behind by vehicles on road surfaces. Skid marks will leave high intensity heat signatures, and thus skidding conditions can be extrapolated from the presence of skid marks. Using this extrapolation, information can be communicated and/or a diagnosis can be made about road and/or vehicle deterioration, including but not limited irregular and/or non-homogenous overheating of surfaces. For example, this information can be communicated to a road maintenance center, to other vehicles on the roadway, and/or to other recipients. The information can be communicated directly, and/or can be communicated by a lighting change or other response or action.

As another example, sudden motion irregularities such as skidding due to dangerous conditions, thereby making portions of the road more accident-prone, can be detected by the method and system. This information can be used, for example, to provide light signaling as a means to alert other vehicles. According to yet another embodiment, the information can be communicated to a traffic management system, thereby providing information that facilitates management of traffic by the system.

According to an embodiment, the system can utilize one or more extracted trajectories and/or estimated trajectories to facilitate office or space management. For example, the system can aggregate information based on usage of the one or more surfaces within the environment, such as common trajectories, floor wear and tear, space usage within an open-office environment, the amount of floor traffic, and/or other information. This information could be communicated to facility management services which can respond accordingly.

According to an embodiment, the system can perform an action at step 480 of the method depending on one or more characteristics of the extracted or estimated trajectory, and/or on one or more characteristics of the object. For example, if the system can determine that the object was a person, and/or that the object was one person or multiple people, and/or that the person was male or female, and/or that the person was a certain age or age range, and/or was a specific person, then the system can provide a tailored response. For example, the system may determine from the gait or other characteristics of the heat signature that the object was likely person X, then the system may response with an action that is preprogrammed or otherwise tailored to person X. These and many other actions are possible in response to the one or more estimated trajectories.

According to an embodiment, the system may utilize one or more pieces of information about the thermal image to determine which, if any, action is taken by the system. The system may comprise one or more predetermined, preprogrammed, or learned rules that can be applied while analyzing a thermal image. For example, the system may utilize or discard an estimated trajectory based on a time and/or date. In the case of a lighting system, for example, the estimated trajectory may not be utilized to activate or modify lighting if it is obtained during daylight hours. As another example, the system may determine which action to take based at least in part on the number of objects that are on or have traveled along the one or more surfaces. For example, the system may take a first action if the number objects is above a threshold, or may take a second action if the number of objects is below a threshold. A family may trigger a first action while a single individual may trigger a second action, although in some instances the first and second actions are the same. According to an embodiment, the system may determine which action is taken based on a determined attribute of the object as determined by the heat signature and/or extracted or estimated trajectory. For example, the system may determine which action is taken based on the sex, height, or motion of an object determined to be a human.

At optional step 480 of the method, the processor extracts information about the object from the detected heat signature on the one or more surfaces. For example, the average speed of the object can be estimated, as there may be a relationship between the average walking speed and the number of steps for a fixed foot stride. According to another embodiment, a rough height estimate of the moving object can also be interpreted from the stride length. According to another embodiment, shape and/or appearance analysis on the thermal signature can also give an indication about specific attributes of the object. In the case of a human, for example, the analysis may be able to determine or estimate whether the human was walking, running, carrying an object, walking forward or backward, male, female, adult, or a child.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for estimating a trajectory of a non-stationary object using thermal imaging, the method comrpising the steps of:
obtaining, using a thermal imager, a thermal image of one or more surfaces within an environment;
detecting, within a single obtained thermal image, a heat signature from an object on the one or more surfaces;
extracting, using the detected heat signature in the single obtained thermal image, a trajectory of the object along the one or more surfaces within the image; and
estimating, from the extracted trajectory, a trajectory of the object within the environment.

2. The method of claim 1, wherein the estimated trajectory is outside the field of view of the thermal image.

3. The method of claim 1, further comprising the step of responding to the estimated trajectory.

4. The method of claim 3, wherein the response comprises communicating information about the estimated trajectory.

5. The method of claim 3, wherein the response comprises communicating, based on the estimated trajectory, information about the one or more surfaces.

6. The method of claim 3, wherein the response comprises modifying, based on the estimated trajectory of the object within the environment, a characteristic of a lighting unit.

7. The method of claim 1, further comprising the step of triggering, in response to a triggering event, the thermal imager to obtain or analyze a thermal image.

8. The method of claim 1, further comprising the step of extracting additional information about the object using the detected heat signature.

9. The method of claim 1, further comprising the step of communicating the thermal image to a processor of the thermal imager or to another thermal imaging device or system.

10. A thermal imaging device configured to estimate a trajectory of a non-stationary object using theremal imaging, the device comprising:
a thermal imager configured to obtain one or more thermal images of one or more surfaces; and
a controller configured to: (i) detect, within a single obtained thermal image, a heat signature from an object on the one or more surfaces; (ii) extract, using the detected heat signature in the single obtained thermal image, a trajectory of the object along the one or more surfaces within the image; and (iii) estimate, from the extracted trajectory, a trajectory of the object within the environment.

11. The thermal imaging device of claim 10, wherein the estimated trajectory is outside the field of view of the thermal image.

12. The thermal imaging device of claim 10, wherein the controller is further configured to respond to the estimated trajectory.

13. A thermal imaging system configured to estimate a trajectory of a non-stationary object using theremal imaging, the device comprising:
a thermal imager component comprising a thermal imager and a communications module, wherein the thermal imager is configured to obtain one or more thermal images of one or more surfaces; and
a controller configured to: (i) receive, from the communications module, one or more of the one or more thermal images; (ii) detect, within a single obtained thermal image, a heat signature from an object on the one or more surfaces; (iii) extract, using the detected heat signature in the single obtained thermal image, a trajectory of the object along the one or more surfaces within the image; and (iv) estimate, from the extracted trajectory, a trajectory of the object within the environment.

14. The thermal imaging system of claim 13, wherein the estimated trajectory is outside the field of view of the thermal image.

15. The thermal imaging system of claim 13, wherein the controller is further configured to respond to the estimated trajectory.
